(19) United States
(12) Patent Application Publication
(10) Pub. No.: US 2023/0125209 A1
(43) Pub. Date: Apr. 27, 2023

(54) TACTILE PRESENTATION APPARATUS, SELF-MOTION PRESENTATION SYSTEM, METHOD THEREFOR, AND PROGRAM

(71) Applicant: NIPPON TELEGRAPH AND TELEPHONE CORPORATION, Tokyo (JP)

(72) Inventors: Shinya TAKAMUKU, Tokyo (JP); Hiroaki GOMI, Tokyo (JP); Ryoma TANASE, Tokyo (JP)

(73) Assignee: NIPPON TELEGRAPH AND TELEPHONE CORPORATION, Tokyo (JP)

(21) Appl. No.: 17/912,463

(22) PCT Filed: Mar. 19, 2020
(86) PCT No.: PCT/JP2020/012263

§ 371 Date: Sep. 16, 2022

(51) Int. Cl. G06F 3/01

(52) U.S. Cl. CPC G06F 3/016

(57) ABSTRACT

A desired self-motion is presented to a user through a tactile stimulus that simulates a tactile stimulus produced by self-motion. A tactile presentation device (1) presents, to a body of the user, a simulated tactile stimulus that simulates a tactile stimulus produced when the user performs a desired self-motion. A control unit (31) generates a drive signal driving the tactile presentation device (1). A drive unit (32) presents the simulated tactile stimulus in accordance with the drive signal. The drive signal is generated on the basis of contact point motion information expressing motion arising at a contact point between the body of the user and the tactile presentation device (1) due to the self-motion. Assuming that the contact point is fixed with respect to an outside world, the contact point motion information corresponds to a change in a relative positional relationship between the body of the user and the contact point arising when the user performs the self-motion.

### TECHNICAL FIELD

The present invention relates to a technique that presents self-motion to a user through tactile stimuli that simulate tactile stimuli produced by self-motion.

### BACKGROUND ART

Motion that changes the position or attitude of a self-body relative to its environment is called “self-motion”. For example, walking is a self-motion. A sensory stimulus that simulates a sensory stimulus produced by self-motion is called a “sensory stimulus that suggests self-motion”. For example, an optical flow having an extended focus in the direction of movement is an example of this. The human brain estimates such self-motion on the basis of a variety of sensory inputs, and uses the information for perception, control, and the like.

Presenting various sensory stimuli that simulate tactile stimuli produced by self-motion and appropriately working with such processes by which the brain estimates self-motion makes it possible to implement a system that presents desired self-motion to a user. Thus far, such systems have used visual stimuli such as optical flows, electrical stimuli to the vestibular system, and the like. Recently, systems that use tactile stimuli that simulate tactile stimuli produced by self-motion have begun to be proposed in order to enhance the sensation of self-motion presented by visual stimuli, adjust the sensation in a desired direction, or the like. For example, NPL 1 discusses the possibility of presenting forward motion by presenting tactile pseudo-motion on a seating surface, and manipulating the perceived speed of self-motion perceived from the observation of expanding dot motion. Additionally, NPL 2 indicates the possibility of manipulating similar perceptions by presenting a tactile stimulus suggesting forward motion by blowing air on the face.

### CITATION LIST

### Non Patent Literature

[NPL 1] Amemiya, T., Hirota, K., & Ikei, Y., “Tactile flow on seat pan modulates perceived forward velocity,” in 2013 IEEE Symposium on 3D User Interfaces (3DUI), pp. 71-77, 2013.
[NPL 2] Seno, T., Ogawa, M., Ito, H., & Sunaga, S., “Consistent Air Flow to the Face Facilitates Vection,” Perception, vol. 40, pp. 1237-1240, 2011.

### SUMMARY OF THE INVENTION

### Technical Problem

However, previously-proposed systems for presenting self-motion using tactile stimuli that simulate the tactile stimuli produced by self-motion were designed assuming that the user and the tactile presentation device are always in a specific relative positional relationship. Accordingly, in situations where the positional relationship changes, it has not been possible to present desired self-motion using tactile stimuli that simulate the tactile stimuli produced by self-motion.

An object of the present invention is to provide a technique capable of presenting desired self-motion to a user through tactile stimuli that simulate tactile stimuli produced by self-motion, in situations where a relative positional relationship between the user and a tactile presentation device change.

### Means for Solving the Problem

To solve the above-described problem, a tactile presentation device according to one aspect of the present invention is a tactile presentation device that presents, to a body of a user, a simulated tactile stimulus that simulates a tactile stimulus produced when the user performs a desired self-motion. The tactile presentation device includes a control unit that generates a drive signal driving the tactile presentation device, and a drive unit that presents the simulated tactile stimulus in accordance with the drive signal. The drive signal is generated on the basis of contact point motion information expressing motion arising at a contact point between the body of the user and the tactile presentation device due to the self-motion. Assuming that the contact point is fixed with respect to an outside world, the contact point motion information corresponds to a change in a relative positional relationship between the body of the user and the contact point arising when the user performs the self-motion.

### Effects of the Invention

According to the present invention, a technique capable of presenting desired self-motion to a user through tactile stimuli that simulate tactile stimuli produced by self-motion, in situations where a relative positional relationship between the user and a tactile presentation device change, can be provided.

### BRIEF DESCRIPTION OF DRAWINGS

FIG. 1 is a diagram illustrating an environment assumed by an embodiment.

FIG. 2 is a diagram illustrating an example of the functional configuration of a self-motion presentation system.

FIG. 3 is a diagram illustrating an example of the functional configuration of a state measurement device.

FIG. 4 is a diagram illustrating operations of the state measurement device.

FIG. 5 is a diagram illustrating an example of the functional configuration of a contact point motion calculation device.

FIG. 6 is a diagram illustrating an example of the functional configuration of a contact point motion calculation device.

FIG. 7 is a diagram illustrating operations of a pre-movement contact point position calculation unit.

FIG. 8 is a diagram illustrating operations of a post-motion contact point position calculation unit.

FIG. 9 is a diagram illustrating operations of a post-movement contact point position calculation unit.

FIG. 10 is a diagram illustrating operations of the post-movement contact point position calculation unit and a contact point displacement calculation unit.

FIG. 11 is a diagram illustrating an example of the functional configuration of a tactile presentation device.

FIG. 12 is a diagram illustrating a case where there are two contact points.

FIG. 13 is a diagram illustrating a case where a tactile stimulus is presented to one hand.

FIG. 14 is a diagram illustrating an example of self-motion suggested by contact point motion.

FIG. 15 is a diagram illustrating an example of self-motion suggested by contact point motion.

FIG. 16 is a diagram illustrating a case where a tactile stimulus is presented to both hands.

FIG. 17 is a diagram illustrating a case where a tactile stimulus is presented to both hands.

FIG. 18 is a diagram illustrating an example of the functional configuration of a computer.

### DESCRIPTION OF EMBODIMENTS

An embodiment of this invention will be described in detail hereinafter. In the drawings, the same numbers are added to constituent elements having the same functions, and redundant descriptions will be omitted.

### Embodiment

An embodiment of the present invention is a self-motion presentation system that presents a sensation of desired self-motion, including at least one of translation and rotation, to a user by using a tactile presentation device that presents tactile stimuli as motion of a contact point on the skin of the user's hand.

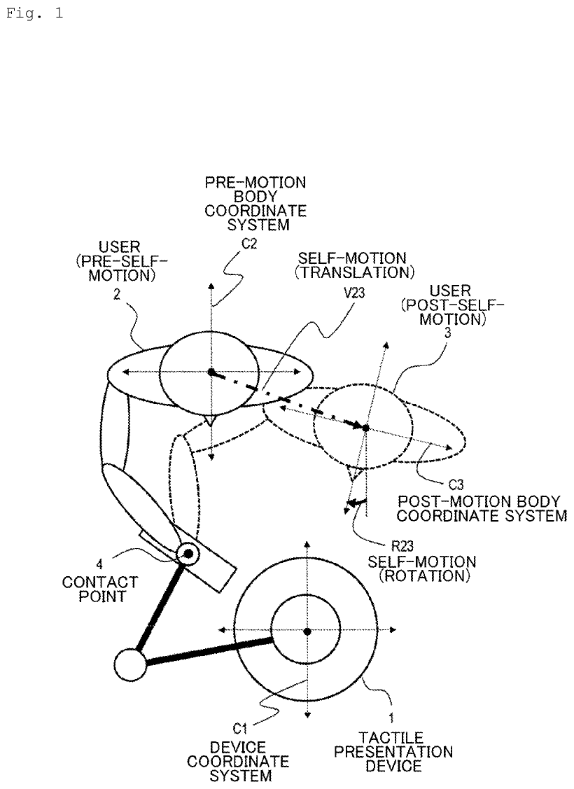

FIG. 1 illustrates a concept of the self-motion presentation system of the embodiment. A tactile presentation device 1 is implemented, for example, as a mobile robot having a robot arm. A user 2 and the tactile presentation device 1 are assumed to be in contact with each other at at least one point. The user 2 and the tactile presentation device 1 may be in point contact or in surface contact. For example, the user may grip a handle or a robot hand attached to an end of the robot arm with their hand, or may press a panel attached to the end of the robot arm with their palm. A point representing the location of contact between the user and the tactile presentation device 1 will be called a “contact point” hereinafter. For example, a point where a member that makes contact with the user is attached at the end of the robot arm may serve as the contact point, or the center of a range where the user and the tactile presentation device 1 make contact may serve as the contact point. The user 2 represents a position, attitude, and the like of their body before the self-motion presented by the self-motion presentation system is performed, and a user 3 represents a position, attitude, and the like of their body that will be realized when the self-motion is performed. The self-motion is defined by self-motion information S23, which includes at least one of translation V23 and rotation R23. The tactile presentation device 1 presents tactile stimuli to the user's hand by driving the robot arm and moving a contact point 4. Through this, the self-motion presentation system presents a sensation of self-motion to the user. The self-motion presentation system can be incorporated into a virtual reality system using, for example, a head-mounted display. In this case, the self-motion presented by an image in the head-mounted display can be simultaneously presented by tactile stimuli to present a clearer sensation of self-motion to the user.

In the present embodiment, the position, attitude, and the like of the user, the position, motion, and the like of the contact point, and the like are defined using a predetermined coordinate system. In the following descriptions, a device coordinate system C1, a pre-motion body coordinate system C2, and a post-motion body coordinate system C3, illustrated in FIG. 1, will be used. The device coordinate system C1 is a coordinate system based on the position and orientation of the tactile presentation device 1. The pre-motion body coordinate system C2 is a coordinate system based on the position and orientation of the pre-self-motion user 2 to be presented. The post-motion body coordinate system C3 is a coordinate system based on the position and orientation of the post-self-motion user 3 to be presented. Although the following assumes that all of the coordinate systems are two-dimensional orthogonal coordinate systems, the coordinate systems are not limited thereto.

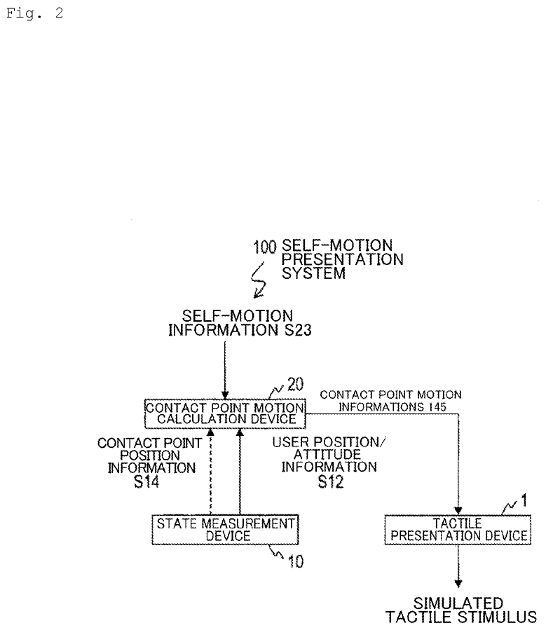

The functional configuration of the self-motion presentation system will be described with reference to FIG. 2. A self-motion presentation system 100 includes, for example, the tactile presentation device 1, a state measurement device 10, and a contact point motion calculation device 20. The self-motion presentation system 100 may be configured as a single device by incorporating the state measurement device 10 and the contact point motion calculation device 20 into the housing of the tactile presentation device 1, or each of the state measurement device 10 and the contact point motion calculation device 20 may be configured as devices separate from the tactile presentation device 1, with the devices configured to communicate with each other over a network or the like.

The state measurement device 10 measures position/attitude information S12 of the user 2 in the device coordinate system C1 (called “user position/attitude information” hereinafter) and position information S14 of the contact point 4 in the device coordinate system C1 (called “contact point position information” hereinafter). The contact point motion calculation device 20 receives the input self-motion information S23 and the user position/attitude information S12 and contact point position information S14 output by the state measurement device 10, and calculates information S145 expressing contact point motion in the device coordinate system C1 to be presented to the user 2 (called “contact point motion information” hereinafter). The tactile presentation device 1 presents tactile stimuli corresponding to the contact point motion (called “simulated tactile stimuli” hereinafter) to the user 2.

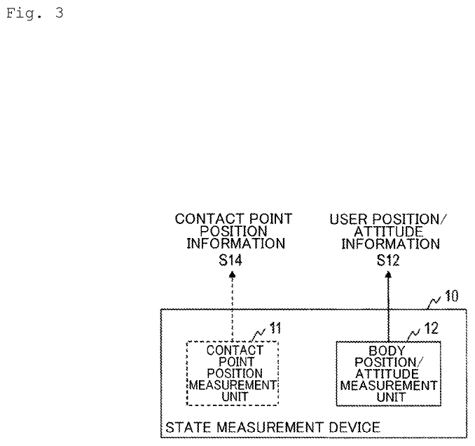

As illustrated in FIG. 3, the state measurement device 10 includes a contact point position measurement unit 11 and a body position/attitude measurement unit 12.

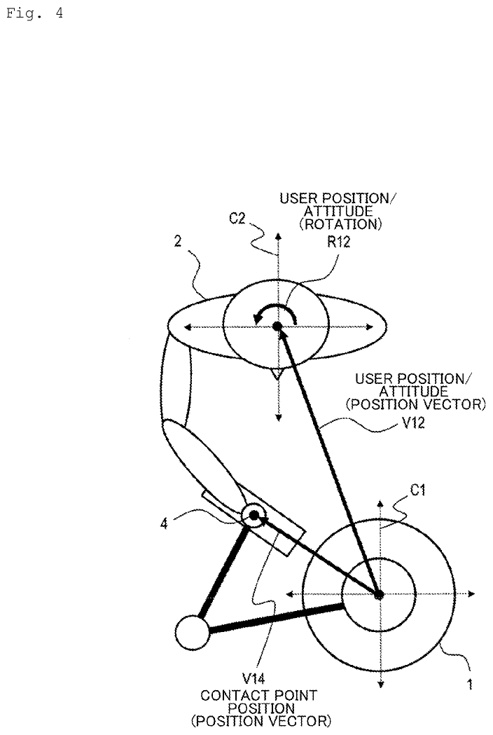

The contact point position measurement unit 11 measures the contact point position information S14 in the device coordinate system C1. As illustrated in FIG. 4, the contact point position information S14 is expressed by a position vector V14 from the tactile presentation device 1 to the contact point 4. In other words, the contact point position information S14 expresses a relative positional relationship between the tactile presentation device 1 and the contact point 4.

The body position/attitude measurement unit 12 measures the user position/attitude information S12 in the device coordinate system C1. As illustrated in FIG. 4, the user position/attitude information S12 is expressed by a position vector V12 from the tactile presentation device 1 to the user 2 and rotation R12 of an axis of the user 2. In other words, the user position/attitude information S12 expresses a relative positional relationship between the tactile presentation device 1 and the user 2.

The contact point position measurement unit 11 uses a sensor such as an encoder of the tactile presentation device 1, a camera fixed to the tactile presentation device 1, or the like, for example. The body position/attitude measurement unit 12 uses a sensor such as a camera fixed to the tactile presentation device 1, a laser rangefinder, a floor sensor installed in the environment, or the like, for example. The contact point position measurement unit 11 and the body position/attitude measurement unit 12 may use a common sensor. Additionally, in a situation where the position of the contact point 4 in the device coordinate system C1 does not change significantly, the state measurement device 10 need not include the contact point position measurement unit 11. In this case, the state measurement device 10 outputs a predetermined value as the contact point position information S14.

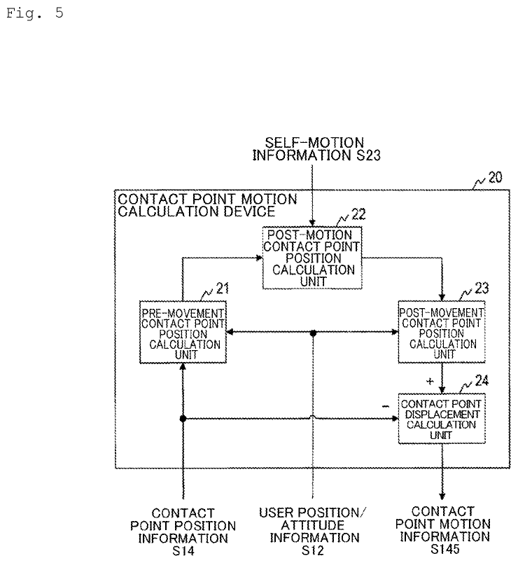

As illustrated in FIG. 5, the contact point motion calculation device 20 includes a pre-movement contact point position calculation unit 21, a post-motion contact point position calculation unit 22, a post-movement contact point position calculation unit 23, and a contact point displacement calculation unit 24.

The pre-movement contact point position calculation unit 21 receives the contact point position information S14 and the user position/attitude information S12 output by the state measurement device 10, and calculates position information S24 of the contact point 4 in the pre-motion body coordinate system C2 (called “pre-movement contact point position information” hereinafter). The pre-movement contact point position information S24 includes a position vector V24 from the user 2 to the contact point 4. In other words, the pre-movement contact point position information S24 expresses a relative positional relationship between the pre-self-motion user 2 and the pre-movement contact point 4.

The post-motion contact point position calculation unit 22 receives the self-motion information S23 input to the contact point motion calculation device 20 and the pre-movement contact point position information S24 output by the pre-movement contact point position calculation unit 21, and calculates position information S34 of the contact point 4 in the post-motion body coordinate system C3 (called “post-motion contact point position information” hereinafter). The post-motion contact point position information S34 includes a position vector V34 from the user 3 to the contact point 4. In other words, the post-motion contact point position information S34 expresses a relative positional relationship between the post-self-motion user 3 and the pre-movement contact point 4.

The post-movement contact point position calculation unit 23 receives the post-motion contact point position information S34 output by the post-motion contact point position calculation unit 22, and calculates position information S15 in the device coordinate system C1 of a position at which the relative positional relationship to the pre-self-motion user 2 corresponds to the post-motion contact point position information S34 (the contact point 4 having moved to this position will be represented by a contact point 5) (called “post-movement contact point position information” hereinafter). The post-movement contact point position information S15 includes a position vector V15 from the tactile presentation device 1 to the contact point 5. In other words, the post-movement contact point position information S15 expresses a relative positional relationship between the pre-self-motion user 2 and the post-movement contact point 5.

The contact point displacement calculation unit 24 receives the contact point position information S14 output by the state measurement device 10 and the post-movement contact point position information S15 output by the post-movement contact point position calculation unit 23, subtracts the position of the pre-movement contact point 4 from the position of the post-movement contact point 5, and calculates a vector V145 expressing displacement of the contact point between before and after the movement (called a “contact point displacement vector” hereinafter).

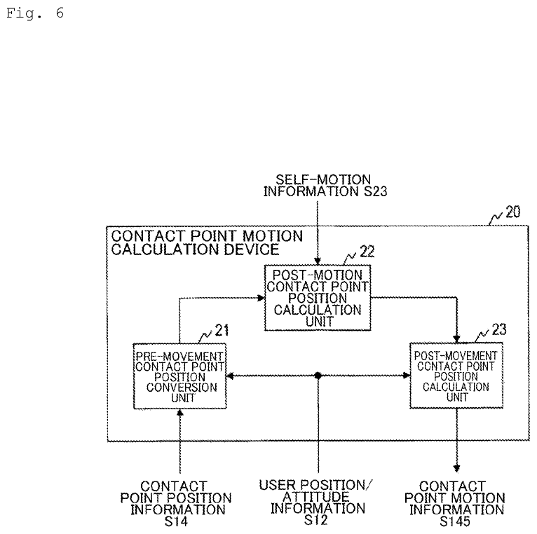

The contact point motion calculation device 20 outputs the contact point displacement vector V145, which has been output by the contact point displacement calculation unit 24, as the contact point motion information S145. Note that the contact point motion calculation device 20 need not include the contact point displacement calculation unit 24, as illustrated in FIG. 6. In this case, the post-movement contact point position information S15 output by the post-movement contact point position calculation unit 23 is output as the contact point motion information S145. In other words, it can be said that the contact point motion information S145 expresses the motion that occurs at the contact point 4 due to self-motion, and corresponds to a change in the relative positional relationship between the body of the user 2 and the contact point 4 that occurs when the user 2 performs self-motion, assuming that the contact point 4 is fixed to the external world.

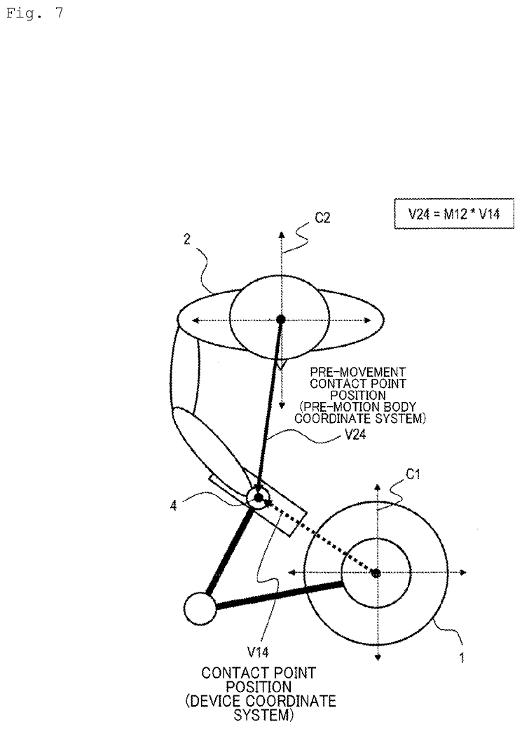

The calculation by the pre-movement contact point position calculation unit 21 will be described in detail with reference to FIG. 7. The pre-movement contact point position calculation unit 21 transforms the position vector V14 of the pre-movement contact point 4 in the device coordinate system C1 into the position vector V24 in the pre-motion body coordinate system C2. This calculation can be performed as follows using a transformation matrix M12 from the device coordinate system C1 to the pre-motion body coordinate system C2. Note that the * indicates matrix multiplication.

V24=M12*V14 [Math 1]

The transformation matrix M12 can be calculated using the user position/attitude information S12 obtained from the state measurement device 10. For example, the following can be written when (x, y) represents the positional coordinates of the contact point 4 in the device coordinate system C1, (x′, y′) represents the positional coordinates of the contact point 4 in the pre-motion body coordinate system C2, (Tx, Ty) represents the positional coordinates of the center of the body of the pre-self-motion user 2 in the device coordinate system C1, and Rz represents an angle of rotation of the axis.

$$( \begin{matrix}{x}^{′} \\ {y}^{′} \\ 1\end{matrix} ) = ( \begin{matrix}cos ( Rz ) & sin ( Rz ) & - Tx cos ( Rz ) - Ty sin ( Rz ) \\ - sin ( Rz ) & cos ( Rz ) & Tx sin ( Rz ) - Ty cos ( Rz ) \\ 0 & 0 & 1\end{matrix} ) ( \begin{matrix}x \\ y \\ 1\end{matrix} ) \qquad [ Math 2 ]$$

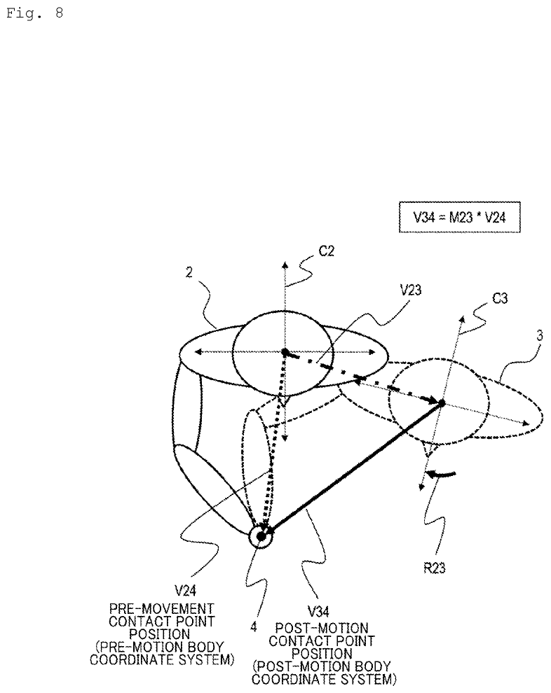

The calculation by the post-motion contact point position calculation unit 22 will be described in detail with reference to FIG. 8. The post-motion contact point position calculation unit 22 transforms the position vector V24 of the pre-movement contact point 4 in the pre-motion body coordinate system C2 into the position vector V34 of the pre-movement contact point 4 in the post-motion body coordinate system C3. This calculation can be performed as follows using a transformation matrix M23 from the pre-motion body coordinate system C2 to the post-motion body coordinate system C3.

V34=M23*V24 [Math 3]

The transformation matrix M23 can be calculated using the self-motion information S23 input to the contact point motion calculation device 20. For example, the following can be written when (x′, y′) represents the positional coordinates of the contact point 4 in the pre-motion body coordinate system C2, (x″, y″) represents the positional coordinates of the contact point 4 in the post-motion body coordinate system C3, (T′x, T′y) represents the positional coordinates of the center of the body of the post-self-motion user 3 in the pre-motion body coordinate system C2, and R′z represents an angle of rotation of the axis resulting from the self-motion.

$$( \begin{matrix}{x}^{″} \\ {y}^{″} \\ 1\end{matrix} ) = ( \begin{matrix}cos ( {R}^{′} z ) & sin ( {R}^{′} z ) & - {T}^{′} x cos ( {R}^{′} z ) - {T}^{′} y sin ( {R}^{′} z ) \\ - sin ( {R}^{′} z ) & cos ( {R}^{′} z ) & {T}^{′} x sin ( {R}^{′} z ) - {T}^{′} y cos ( {R}^{′} z ) \\ 0 & 0 & 1\end{matrix} ) ( \begin{matrix}{x}^{′} \\ {y}^{′} \\ 1\end{matrix} ) \qquad [ Math 4 ]$$

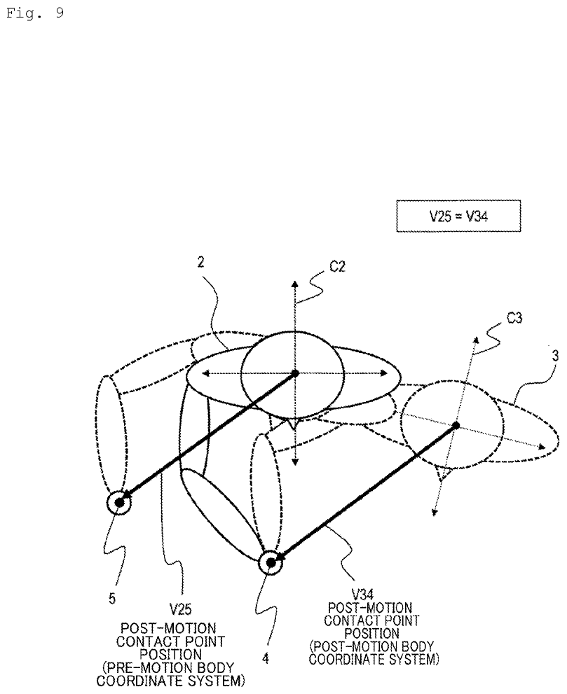

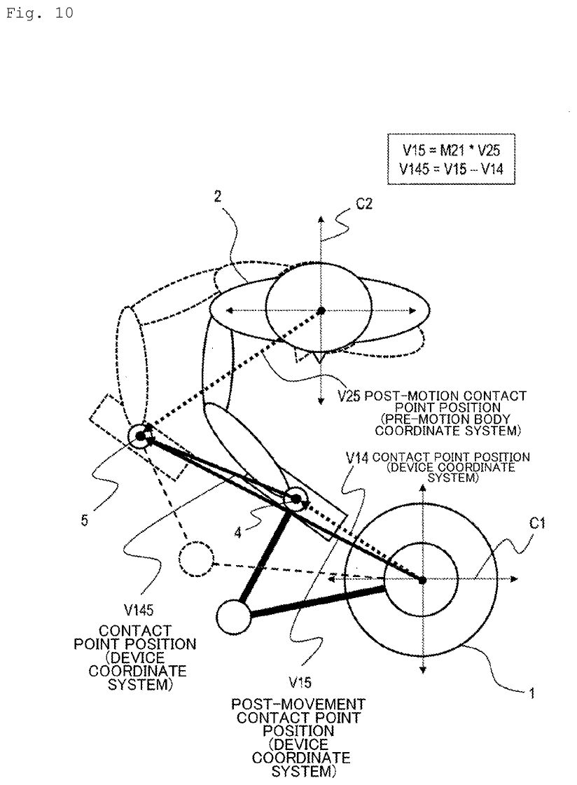

The calculation by the post-movement contact point position calculation unit 23 and the contact point displacement calculation unit 24 will be described in detail with reference to FIG. 9 and FIG. 10. As illustrated in FIG. 9, the post-movement contact point position calculation unit 23 obtains, as information expressing the position of the post-movement contact point 5, a position vector V25 in the pre-motion body coordinate system C2 corresponding to the position vector V34 in the post-motion body coordinate system C3. Next, as illustrated in FIG. 10, the post-movement contact point position calculation unit 23 transforms the position vector V25 of the post-movement contact point 5 in the pre-motion body coordinate system C2 into the position vector V15 of the post-movement contact point 5 in the device coordinate system C1. This calculation can be performed as follows using a transformation matrix M21 from the pre-motion body coordinate system C2 to the device coordinate system C1.

V15=M21*V34 [Math 5]

The transformation matrix M21 can be calculated using the user position/attitude information S12 obtained from the state measurement device 10. For example, the following can be written when (x″, y″) represents the positional coordinates of the pre-movement contact point 4 in the post-motion body coordinate system C3, (x′″, y′″) represents the positional coordinates of the post-movement contact point 5 in the pre-motion body coordinate system C2, (Tx, Ty) represents the positional coordinates of the center of the body of the pre-self-motion user 2 in the device coordinate system C1, and Rz represents an angle of rotation of the axis.

$$( \begin{matrix}{x}^{′′′} \\ {y}^{′′′} \\ 1\end{matrix} ) = ( \begin{matrix}cos ( Rz ) & - sin ( Rz ) & Tx \\ sin ( Rz ) & cos ( Rz ) & Ty \\ 0 & 0 & 1\end{matrix} ) ( \begin{matrix}{x}^{′′} \\ {y}^{′′} \\ 1\end{matrix} ) \qquad [ Math 6 ]$$

As illustrated in FIG. 10, the contact point displacement calculation unit 24 calculates the contact point displacement vector V145 as follows using the position vector V15 of the post-movement contact point 5 in the device coordinate system C1 and the position vector V14 of the pre-movement contact point 4 in the device coordinate system C1.

V145=V15−V14 [Math 7]

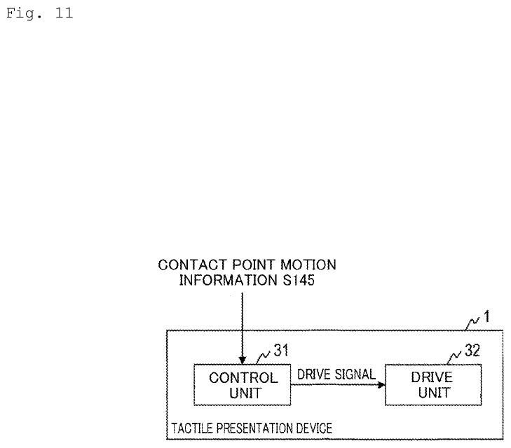

As illustrated in FIG. 11, the tactile presentation device 1 includes a control unit 31 and a drive unit 32. The control unit 31 receives the contact point motion information S145 output by the contact point motion calculation device 20 and generates a drive signal for driving the tactile presentation device 1. The drive unit 32 drives the tactile presentation device 1 on the basis of the drive signal output by the control unit 31.

The tactile presentation device 1 presents the contact point motion as, for example, a change in the position of the contact point between the user 2 and the tactile presentation device 1. For example, the tactile presentation device 1 moves the robot arm such that the end of the robot arm moves from the position of the pre-movement contact point 4 to the position of the post-movement contact point 5. The tactile presentation device 1 may also present tactile motion or tactile pseudo-motion of a length proportional to the magnitude of the contact point displacement vector V145 in the direction indicated by the contact point displacement vector V145. Furthermore, the tactile presentation device 1 may present contact point motion as a force sensation by applying skin deformation, external force, symmetrical vibration, or asymmetrical vibration of a magnitude proportional to the magnitude of the contact point displacement vector V145 in the direction indicated by the contact point displacement vector V145.

Variations

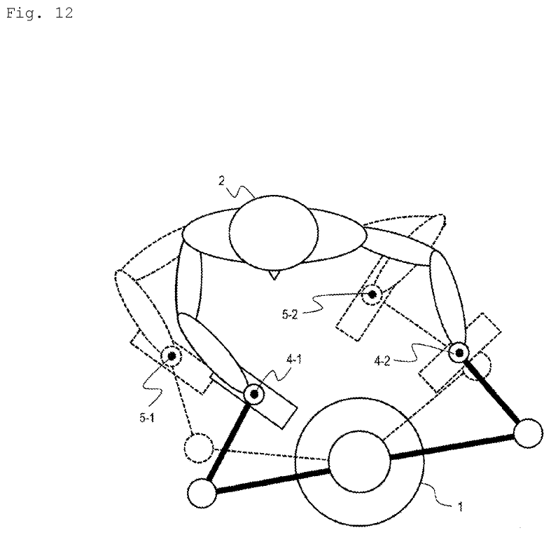

Although the foregoing embodiment described calculations in the case where there is one contact point between the user 2 and the tactile presentation device 1, there may be a plurality of contact points between the user 2 and the tactile presentation device 1. In this case, as illustrated in FIG. 12, the calculations of the embodiment may be repeated for individual contact points 4-1 and 4-2, and the contact point motion calculated for each contact point may be presented.

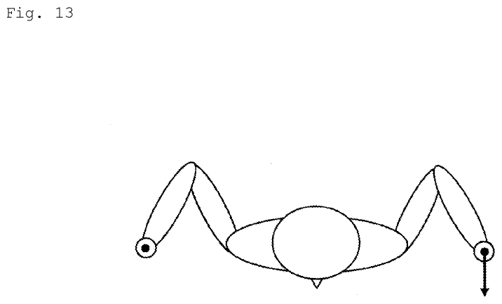

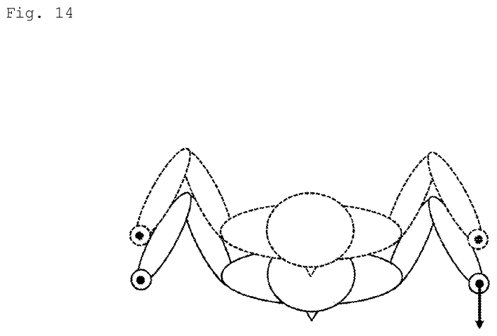

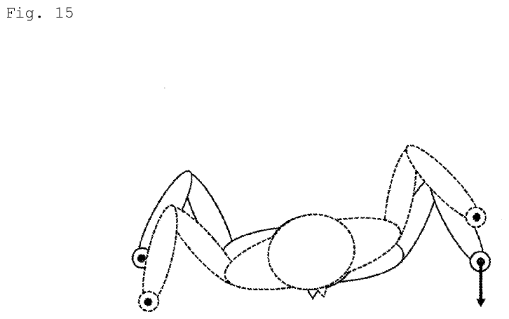

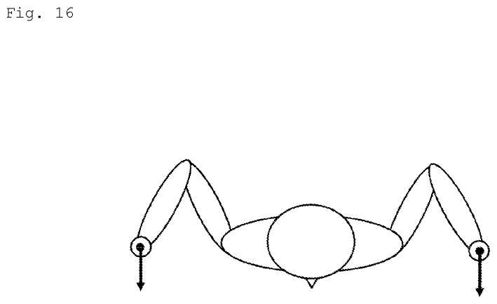

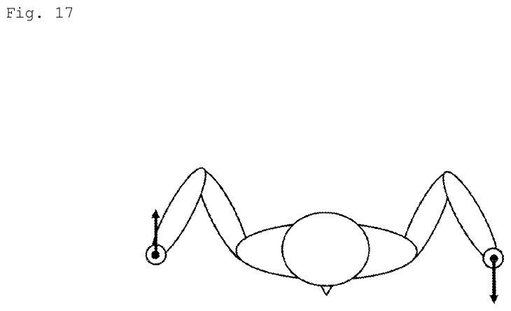

When presenting a plurality of contact point motions simultaneously, the self-motion suggested by the tactile stimuli can be limited more than when presenting a single contact point motion. For example, assume that a contact point motion which pulls forward only on one point of the user's left hand is presented, as illustrated in FIG. 13. In this case, the presented contact point motion can be interpreted as being caused by a backward motion, as illustrated in FIG. 14, or by rotational motion, as illustrated in FIG. 15. As such, the presentation of a single contact point motion alone may not enable an unambiguous interpretation of the self-motion presented to the user. As opposed to this, for example, if contact point motion of the same direction and magnitude is presented to the left and right hands in opposite directions and equidistant from the center of the body, as illustrated in FIG. 16, the interpretation of self-motion can be limited to the translational motion illustrated in FIG. 14. Additionally, for example, if contact point motion of the same magnitude and in opposite directions is presented to the left and right hands in the same attitude, as illustrated in FIG. 17, the interpretation of self-motion can be limited to the rotational motion illustrated in FIG. 15. In this manner, if the calculation described in the embodiment are performed for each of the plurality of contact points, individual contact point motions can be appropriately selected according to the distance, direction, and the like of each contact point, and a sufficiently limited self-motion can be presented by the plurality of contact point motions.

### Application Example

An application is conceivable in which a mobile tactile presentation device is used to present self-motion to a user and guide the user to a desired route or destination in a situation where the user is moving, such as walking in a city. An application is also conceivable in which walking motion is stabilized by attaching or incorporating a tactile presentation device to a cane, a mobile terminal, or the like used by an elderly or disabled person, and inducing attitude responses, walking responses, and the like that compensate the presented self-motion.

Although embodiments of the invention have been described thus far, the specific configuration is not intended to be limited to these embodiments, and it goes without saying that changes to the design and the like, to the extent that they do not depart from the essential spirit of the invention, are included in the invention. The various types of processing described in the embodiments need not be executed in time series according to the order in the descriptions, and may instead be executed in parallel or individually as necessary or in accordance with the processing capabilities of the device executing the processing.

Program and Recording Medium

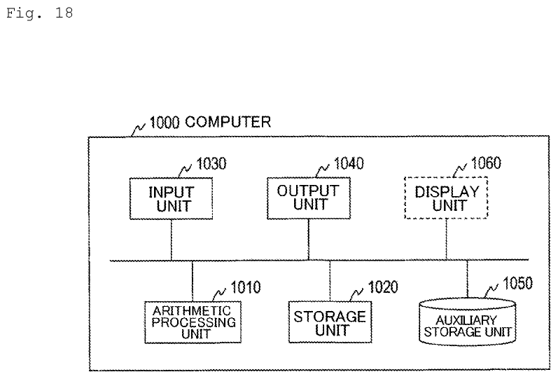

When the various processing functions of the respective devices described in the foregoing embodiments are implemented by a computer, the processing content of the functions which the devices are to have are written in a program. Then, by loading the program into a storage unit 1020 of the computer illustrated in FIG. 18 and having an arithmetic processing unit 1010, an input unit 1030, and output unit 1040, and the like run the program, the various processing functions of each of the above devices are implemented by the computer.

The program in which the processing details are written can be recorded into a computer-readable recording medium. The computer-readable recording medium is, for example, a non-transitory recording medium, and is a magnetic recording device, an optical disk, or the like.

Additionally, the program is distributed by, for example, selling, transferring, or lending portable recording media such as DVDs and CD-ROMs in which the program is recorded. Furthermore, the configuration may be such that the program is distributed by storing this program in a storage device of a server computer and transferring the program from the server computer to another computer over a network.

A computer executing such a program first stores the program recorded in the portable recording medium or the program transferred from the server computer, for example, in an auxiliary recording unit 1050, which is its own non-transitory storage device. Then, when executing the processing, the computer loads the program stored in the auxiliary recording unit 1050, which is its own non-transitory storage device, into the storage unit 1020, which is a transitory storage device, and executes processing in accordance with the loaded program. As another way to execute the program, the computer may load the program directly from the portable recording medium and execute the processing in accordance with the program, and furthermore, each time a program is transferred to the computer from the server computer, processing according to the received programs may be executed sequentially. Additionally, the configuration may be such that the above-described processing is executed by what is known as an ASP (Application Service Provider)-type service that implements the processing functions only by instructing execution and obtaining results, without transferring the program from the server computer to the computer in question. Note that the program according to this embodiment includes information that is provided for use in processing by an electronic computer and that is based on the program (such as data that is not a direct command to a computer but has a property of defining processing by the computer).

Additionally, although these devices are configured by causing a computer to execute a predetermined program in this embodiment, the details of the processing may be at least partially realized by hardware.

1. A tactile presentation device that presents, to a body of a user, a simulated tactile stimulus that simulates a tactile stimulus produced when the user performs a desired self-motion, the tactile presentation device comprising a processor configured to execute a method comprising:
generating a drive signal driving the tactile presentation device; and
presenting the simulated tactile stimulus in accordance with the drive signal,
wherein the drive signal is generated on the basis of contact point motion information expressing motion arising at a contact point between the body of the user and the tactile presentation device due to the self-motion, and
assuming that the contact point is fixed with respect to an outside world, the contact point motion information corresponds to a change in a relative positional relationship between the body of the user and the contact point arising when the user performs the self-motion.

2. The tactile presentation device according to claim 1,
wherein a plurality of contact points between the body of the user and the tactile presentation device are present,
the processor further configured to execute a method comprising:
generating the drive signal corresponding to a contact point of the plurality of contact points on the basis of contact point motion information calculated for each of the plurality of contact points, and
presenting the simulated tactile stimulus at the contact point of the plurality of contact points.

3. The tactile presentation device according to claim 1,
wherein the presenting further comprises presenting the simulated tactile stimulus as a force sensation according to a direction and a magnitude of a change in a position of the contact point expressed by the contact point motion information.

4. A self-motion presentation system comprising a processor configured to execute a method comprising:
generating a drive signal driving a tactile presentation device;
presenting a simulated tactile stimulus in accordance with the drive signal,
wherein the drive signal is generated on the basis of contact point motion information expressing motion arising at a contact point between a body of the user and the tactile presentation device due to a self-motion, and
assuming that the contact point is fixed with respect to an outside world, the contact point motion information corresponds to a change in a relative positional relationship between the body of the user and the contact point arising when the user performs the self-motion;
measuring user position/attitude information expressing a position and an attitude of the body of the user relative to the tactile presentation device; and
calculating the contact point motion information on the basis of self-motion information expressing the self-motion and the user position/attitude information.

5. The self-motion presentation system according to claim 4,
converting contact point position information expressing a relative positional relationship between the tactile presentation device and the contact point into pre-movement contact point position information expressing a relative positional relationship between the body of the user and the contact point before the self-motion;
calculating, using the pre-movement contact point position information and the self-motion information, post-motion contact point position information expressing a relative positional relationship between the body of the user and the contact point after the self-motion; and
calculating post-movement contact point position information expressing a relative positional relationship between the tactile presentation device and the contact point after the movement, using, as a position of the contact point after the movement, a position at which a relative positional relationship with the body of the user before the self-motion corresponds to the post-motion contact point position information.

6. The self-motion presentation system according to claim 5,
calculating, from the post-movement contact point position information and the contact point position information, a displacement of the position of the contact point caused by the self-motion.

7. A tactile presentation method executed by a tactile presentation device that presents, to a body of a user, a simulated tactile stimulus that simulates a tactile stimulus produced when the user performs a desired self-motion, the tactile presentation method comprising:
generating a drive signal driving the tactile presentation device; and
presenting the simulated tactile stimulus in accordance with the drive signal,
wherein the drive signal is generated on the basis of contact point motion information expressing motion arising at a contact point between the body of the user and the tactile presentation device due to the self-motion, and
assuming that the contact point is fixed with respect to an outside world, the contact point motion information corresponds to a change in a relative positional relationship between the body of the user and the contact point arising when the user performs the self-motion.

8. (canceled)

9. The tactile presentation device according to claim 2,
wherein the presenting further comprises presenting the simulated tactile stimulus as a force sensation according to a direction and a magnitude of a change in a position of the contact point expressed by the contact point motion information.

10. The self-motion presentation system according to claim 4, wherein a plurality of contact points between the body of the user and the tactile presentation device are present,
the processor further configured to execute a method comprising:
generating the drive signal corresponding to a contact point of the plurality of contact points on the basis of contact point motion information calculated for each of the plurality of contact points, and
presenting the simulated tactile stimulus at the contact point of the plurality of contact points.

11. The self-motion presentation system according to claim 4,
wherein the presenting further comprises presenting the simulated tactile stimulus as a force sensation according to a direction and a magnitude of a change in a position of the contact point expressed by the contact point motion information.

12. The tactile presentation method according to claim 7,
wherein a plurality of contact points between the body of the user and the tactile presentation device are present,
the method further comprising:
generating the drive signal corresponding to a contact point of the plurality of contact points on the basis of contact point motion information calculated for each of the plurality of contact points, and
presenting the simulated tactile stimulus at the contact point of the plurality of contact points.

13. The tactile presentation method according to claim 7,
wherein the presenting further comprises presenting the simulated tactile stimulus as a force sensation according to a direction and a magnitude of a change in a position of the contact point expressed by the contact point motion information.

14. The tactile presentation method according to claim 12,
wherein the presenting further comprises presenting the simulated tactile stimulus as a force sensation according to a direction and a magnitude of a change in a position of the contact point expressed by the contact point motion information.
